(19) United States
(12) Patent Application Publication
(10) Pub. No.: US 2024/0216928 A1
(43) Pub. Date: Jul. 4, 2024

(54) PERSONAL RECHARGEABLE PORTABLE IONIC AIR PURIFIER

(71) Applicant: Headwaters, Inc., Marblehead, MA (US)

(72) Inventor: Troy Anderson, Marblehead, MA (US)

(21) Appl. No.: 18/148,545

(22) Filed: Dec. 30, 2022

(51) Int. Cl. B03C 3/32; B03C 3/04; B03C 3/38; B03C 3/47; F24F 8/30; F24F 11/30; F24F 11/88

(52) U.S. Cl. CPC B03C 3/32; B03C 3/04; B03C 3/38; B03C 3/47; F24F 8/30; F24F 11/30; F24F 11/88; F24F 2110/65

(57) ABSTRACT

The personal rechargeable portable ionic air purifier of the present invention controllably provides ions to energize personal airspaces and to clean personal airspaces such as that of a taxicab or airplane cabin or other environ of viruses, bacteria, pollen, smoke, mold, dust mites, and other particulate pollutants while posing little or no personal shock risk to average users or others in the environ or to others such as to users of pacemakers concerned with the currents produced by air purifiers, provides intuitive and informative operational modes, provides for replacement or interchange of worn or defective ion emitter heads in a manner that secures the emitter head against unintended dislodgement while allowing ease of attachment or interchange when worn out or defective, exhibits a long battery life and among other advantageous aspects is manufacturable at comparatively low cost.

### CROSS-REFERENCE TO RELATED INVENTIONS

This application is related to U.S. Pat. No. 7,215,526, entitled lon Generator with Open Emitter and Safety Feature, issued May 8, 2007 to Joannou; to U.S. Pat. No. 7,595,030, entitled Air-circulating, Ionizing, Air Cleaner, issued Sep. 29, 2009 to Joannou; to U.S. Pat. No. 6,919,053, entitled Portable lon Generator and Dust Collector, issued Jul. 19, 2005 to Joannou; to U.S. Pat. No. 9,737,895, entitled Personal Rechargeable Portable Ionic Air Purifier, issued Aug. 22, 2017 to Genereux; to U.S. Pat. No. 11,040,354, entitled Personal Rechargeable Portable Ionic Air Purifier, issued Jun. 22, 2021 to Vandenbelt; to Vandenbelt, U.S. utility application Ser. No. 17/352,544, entitled Personal Rechargeable Portable Ionic Air Purifier, filed Jun. 21, 2021, US patent publication 2021-0308693 A1, and to Anderson, U.S. utility application Ser. No. 17/351,847, entitled Ionizers Having Carbon Nanotube lon Emitting Heads, US patent publication 2021-0394202 A1, filed Jun. 18, 2021; each incorporated herein by reference in their entirety.

### FIELD OF THE INVENTION

The present invention relates to ion generators, and more particularly, to battery-operated portable ion generators for personal use and for air purification.

### BACKGROUND OF THE INVENTION

Portable ionic air purifiers are called upon to controllably provide ions to energize and to clean a polluted personal airspace such as that of a taxicab or airplane cabin or other environ of viruses, pollen, smoke, mold, dust mites, and other particulate pollutants while posing little or no personal shock risk to average users or to others such as to users of pacemakers or others concerned with the currents produced by air purifiers, to provide intuitive and informative operational modes, to provide for replacement or interchange of worn or defective ion emitters in a manner that secures the ion emitter against unintended dislodgement while allowing ease of interchange, and among other things to exhibit a long battery life and to be manufacturable at low cost. The heretofore known portable ionic air purifiers, such as the aforesaid U.S. Pat. Nos. 7,215,526, 6,919,053, 9,737,895, 11,040,354, and US patent publications 2021-0308693 and 2021-0394202 however, are disadvantageous in one or more of these or other aspects.

### SUMMARY OF THE INVENTION

The personal rechargeable portable ionic air purifier of the present invention controllably provides ions to energize personal airspaces and to clean personal airspaces such as that of a taxicab or airplane cabin or other environ of viruses, bacteria, pollen, smoke, mold, dust mites, and other particulate pollutants while posing little or no personal shock risk to average users or others in the environ or to others such as to users of pacemakers concerned with the currents produced by air purifiers, provides intuitive and informative operational modes, provides for replacement or interchange of worn or defective ion emitter heads in a manner that secures the emitter head against unintended dislodgement while allowing ease of attachment or interchange when worn out or defective, exhibits a long battery life and among other advantageous aspects is manufacturable at comparatively low cost.

One object of the present invention is to provide for replacement or interchange of worn or defective ion emitter heads in a manner that mechanically releasably secures the emitter head against unintended dislodgement while allowing ease of attachment or interchange when worn out or defective.

In accord therewith, the portable personal ionic air purifier energizing a personal breathable air space with ions and cleaning particulate pollutants therefrom of the present invention includes a housing body having a longitudinal axis, opposing top and bottom ends in spaced-apart relation along said longitudinal axis, a neck at the top end of the housing body and an ionization circuit mounted in the housing body providing a signal at ionization potential. An ion emitter head having opposing outer and inside surfaces and an ion emitter longitudinally-extending from off said outer surface thereof is mounted for slidable motion defined along said longitudinal axis to said neck of said housing body such that said emitter head is releasably secured mechanically to said neck against unintentionally caused dislodgment while allowing ease of interchange and electrical connection between said ion emitter and said signal at ionization potential by action of electrically-conductive magnetic catch and release.

In the presently preferred embodiment, the ion emitter head includes a first electrically-conductive plate that extends transversely of the longitudinal axis mounted to the inside surface of the ion emitter head that is electrically connected to said ion emitter thereof; a pair of spaced-apart and electrically-conductive parallel magnets of the same polarity mounted to the neck of the housing body such that the magnets provide a magnetic field having a direction that points along the longitudinal axis towards and subtends the ion emitter; and a second electrically-conductive plate that extends transversely of the longitudinal axis that is mounted to said neck and that is electrically connected to said signal at ionization potential. In other embodiments a different number and or arrangement and or polarity of magnets may be used.

The longitudinally-extending ion emitter is believed to synergistically cooperate with the magnetic field that points along the longitudinal axis provided between the pair of spaced apart parallel magnets to augment ion flow in the breathable air space.

The first electrically-conductive plate of the emitter head is releasably attached to the pair of parallel magnets mounted to the neck of the housing body by action of magnetic catch and release and the signal at ionization potential is electrically connected to said emitter via the first and second transversely-extending conductive plates and said pair of parallel electrically-conductive magnets sandwiched between.

The inside surface of the ion emitter head includes a longitudinally-extending cantilever arm and first and second spaced-apart longitudinally-extending walls defining first and second longitudinally-extending guide slots that respectively cooperate with a catch and first and second spaced-apart guide rails provided on the neck of the housing body to mechanically releasably secure the emitter head and housing body against unintended dislodgment during use, storage and transport.

Another object of the present invention is to provide a lanyard/back plate ground current management means for a portable, rechargeable, personal ionic air purifier for providing a means to control ground current in multi-steps of impedance in a portable battery operated ionic emissions device that will allow for control of shock risk for average users, for others in the environ and for others such as users of pacemakers concerned with the currents produced by air purifiers when worn by a lanyard.

In accord therewith, the portable personal ionic air purifier energizing a personal breathable air space with ions and cleaning particulate pollutants therefrom of the present invention includes a housing; an ionization circuit having a terminal connected to electrical ground and an output providing a signal at ionization potential; an ion emitter that emits ions when energized at ionization potential by said signal at ionization potential along a circuit path that includes said ion emitter and said terminal at ground potential; and a multi-level impedance network connected in said circuit to selectively vary the impedance between one of the extremes of comparatively-high and comparatively-low impedance and at least one (1) impedance value between said extremes.

Another object of the present invention is to provide intuitive and informative operational modes via I/O means local to the purifier and/or via remote control.

In accord therewith, in one presently preferred remotely-controlled embodiment, the portable personal ionic air parameters energizing a personal breathable air space with ions and cleaning particulate pollutants therefrom of the present invention includes a housing adapted to be transportable and personally worn; an ion emitter outwardly extending from said housing; an electronics module in the housing including a controller and an ionization circuit having a terminal connected to electrical ground and an output that provides a signal at ionization potential; said ion emitter, that emits ions when energized by said signal at ionization potential, is connected along a circuit that includes said ion emitter and said terminal at ground potential causing thereby ground current to flow along said circuit path; and a remote control device, such as a smart phone app, having a controller and GUI that cooperates with said controller of said electronics module to controllably provide intuitive and informative operational modes in different selectable operable states. In a disclosed change signal at ionization potential state, said signal at ionization potential is controllably varied to change ion flow in the breathable air space. In a disclosed change ground conductivity state, the impedance of said circuit path is controllably selected to change the ion flow in the breathable air space between comparatively-high and comparatively-low extremes of ion flow and at least one (1) level of ion flow therebetween. In a disclosed run state, selectable air purifier parameters such as battery life, health and hours of operation are determined and displayed. In a disclosed weather and user environment state, among other things selectable environmental parameters such as forecast pollution levels, allergens, etc are determined and displayed.

### BRIEF DESCRIPTION OF THE DRAWINGS

These and other objects, advantages features and inventive aspects of the present invention will become apparent as the invention becomes better understood by reference to the following detailed description of the presently preferred embodiments thereof, and to the drawings, wherein:

FIG. 1 is a pictorial view of the top and back of the portable rechargeable personal ionic air purifier in accord with the present invention;

FIG. 2 is a partial exploded pictorial view showing the emitter head detached from the housing body and the neck of the housing to which it is releasably attached of the portable rechargeable personal ionic air purifier of present invention;

FIG. 3 is a partial exploded pictorial view showing the emitter head detached from the housing body and the inside surface of the emitter head in its detached condition of the portable rechargeable personal ionic air purifier of present invention;

FIG. 4 is a partial broken away pictorial view showing the emitter head mounted to the neck of the housing body of the portable rechargeable personal ionic air purifier of present invention;

FIG. 5 is a pictorial diagram that schematically illustrates the synergy provided between the ion emitter of the ion emitter head and the pair of parallel magnets of the neck of the housing body of the portable rechargeable personal ionic air purifier in accord with the present invention;

FIG. 6 is a schematic block diagram of the electrical circuitry of one presently preferred remotely-controlled embodiment of the portable personal ionic air purifier energizing a personal breathable air space with ions and cleaning particulate pollutants therefrom in accord with the present invention; and

FIG. 7 is a state diagram of the controller of the remotely-controlled embodiment of the portable rechargeable personal ionic air purifier in accord with the present invention.

### DETAILED DESCRIPTION OF THE PRESENTLY PREFERRED EMBODIMENTS

It is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

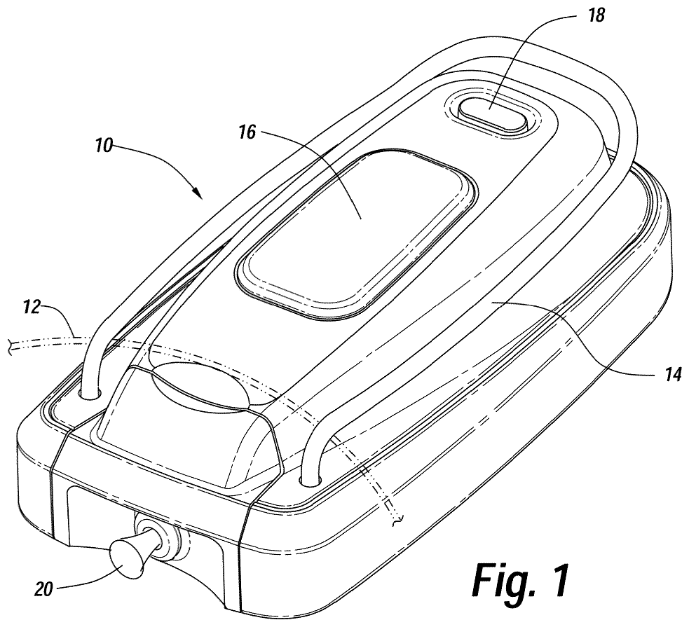

Turning now descriptively to the drawings, FIG. 1 illustrates generally at 10 the portable, rechargeable, personal ionic air purifier 10 of the present invention. The user hangs the purifier 10 around their neck using the conductive cord or lanyard 12 that is captured by a conductive member 14 attached to the back surface of the purifier 12 and electrically connected to electrical ground. A ground plate 16 of electrically-conductive material is mounted to the purifier 10 and is electrically connected to ground potential.

The elongated conductive member 14 is shaped to provide a resilient conductive jaw external to the housing at ground potential, although it could be differently configured. The lanyard 12 is captured by the conductive member 14, which, because the conductive member is electrically grounded, is also electrically grounded, and which, when the lanyard 12 is worn about the neck, establishes the body of the user, not shown, at the same potential as the ground potential. The lanyard 12 is as easily removed as it is inserted into the resilient jaw provided by the conductive member 14.

Since no specialized plug ends are required, the lanyard 12 may be a simple loop of conductive material. The lanyard 12 may also be the user's own silver and/or gold neckwear. The resilient jaw provided by conductive member 14 is capable of receiving an article of clothing between it and the confronting surface of the purifier 12, which permits the mounting of the purifier 12 on an article of clothing, such as a T-shirt or sleeve or other article of clothing, not shown. When the article of clothing of whatever variety is removably received by the resilient jaw provided by the conductive member 14, the ground plate 16 contacts the confronting portion of the surface of the body of the user, which establishes the body of the user, not shown, at the same potential as the ground potential. The article of clothing is as easily removed as it is inserted into the resilient jaw provided by the conductive member 14.

The conductive member 14 may be variously configured to releasably grasp the lanyard and/or an article of clothing.

The ground plate 16 in alternative embodiments, not shown, may be employed to transfer ground to a desk mount, or a bed stand, or may even be used with a wristband, or armband, or other device for attaching the wearable housing to an intended body part, all not shown.

The purifier 10 is turned “on” using the LED switch 18. A cloud of ions, not shown, is thereby produced off of carbon brush 20, or other ion emitter, such as the carbon nanotube (CNT) ion emitters of the aforesaid US patent publication 2021-0394202, that is directed towards the facial area, not shown, to energize the personal breathable airspace with ions and remove particulates therefrom. These ions attract opposite charged particles in the air and are then attracted together towards the nearest ground source. The conductive lanyard 12 ensures that the ground source is the body of the user and not the breathable air stream, thus effectively cleaning the breathable air stream of contaminants in the air and/or producing negative ions. A USB cable or other interface, not shown, may be used to recharge its internal battery, not shown. The LED switch 18 provides a signal indication of charge and/or use status of the purifier 10; preferably flashing “green” when emitting ions, flashing “yellow” when the battery is low, and solid “red” when charging.

The purifier cleans the air, typically about a three-foot sphere about the head when the purifier is worn about the neck using the lanyard, of viruses, bacteria, pollen, smoke, mold, dust mites and other particulate-pollutants. The purifier can also be placed, for example, on a night stand, so that the air around the pillow area is purified of pollutants, or located nearby on a table, seat or anywhere else energization by negative ions and/or purification may be desired or necessary.

It is known from U.S. Pat. No. 6,919,053 that a grounded surface in proximity of a high voltage ion source increases the production of ions. Ideally an electrical connection is formed between the ground terminal of the high voltage source and the surface in question. In the case of a personal air purifier, this connection is achieved through a conductive fabric lanyard which is in contact with the user's skin. The fabric is ideally composed of ordinary fabric with conductive elements interweaved. The conductivity of the fabric can be achieved using a multitude of methods, some of which will desirably provide a more comfortable user experience than others.

The conductive grounding neck strap allows for the device to use the body of the person wearing the purifier as a ground source. This has the effect of providing a large ground plane and a significant increase in ion output from the purifier. The strap is generally of cotton or polyester construction with interwoven layers of conductive materials. It is connected directly to the floating ground in the device and concurrently to the individual user while hanging around the neck and/or in contact with bare skin.

The ground cord may be constructed of any type of conductive materials. The ground plate 16 in contact with the body of the user can substitute for the cord if required. Other grounding means may be employed.

Although any suitable electrical circuitry to convert the battery power to ionization potential may be employed, preferably, the safe, and high-efficiency, electrical circuitry providing a pulse train controllable in duty cycle, frequency, and among others magnitude shown and described in U.S. Pat. No. 9,737,895, incorporated herein by reference, is preferably employed to controllably energize the ion emitter 18 to safely emit ions at ionization potential during use. Nonrechargeable battery sources may also be used for operation of the purifier.

As disclosed in U.S. Pat. No. 9,737,895, among other ways to temporarily vary on-demand ion generation, the potential may be increased beyond the ionization potential whenever it is desired to boost ion generation in dirty or other especially polluted environments or to provide a boost of energizing ions but at the expense of an increased shock risk and consumption of battery power; and by changing the duty cycle and or frequency of the pulse train. Increasing the pulse length and/or frequency increases ion emission when air quality is bad or a boost of energizing ions is important; conversely, decreasing the pulse length and/or frequency of the pulse train decreases ion emission whenever air quality is not too bad or it is important to conserve battery power and therewith battery life.

Another way to temporarily decrease ion generation disclosed therein is to disconnect the lanyard from electrical ground. When the lanyard is connected to ground, ion generation would be comparatively-high, whereas were the lanyard disconnected from ground, ion generation would be comparatively-low.

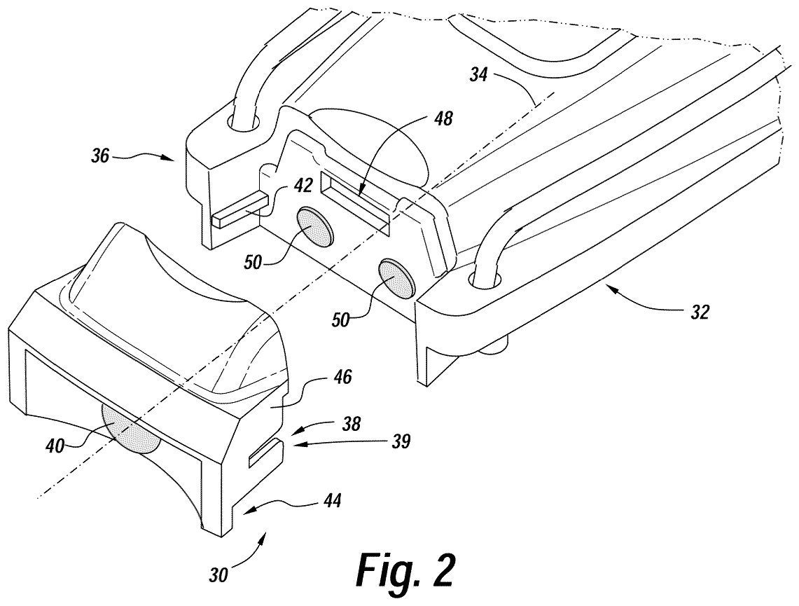

Referring now to FIG. 2, generally designated at 30 is a partial exploded pictorial view of the portable rechargeable personal ionic air purifier in accord with the present invention. The purifier 30 includes a wearable housing body generally designated 32 having a longitudinal axis and center line illustrated by dashed line 34 and a neck generally designated 36 at the top of the housing body 32. An emitter head generally designated 38 having an ion emitter 40 is mounted for longitudinal sliding motion to the housing body 32. A pair of spaced-apart guide rails 42 are provided on the neck 36 that cooperate with a pair of spaced-apart guide grooves generally designated 39 provided on the emitter head 38 to provide ease of emitter head attachment and detachment from the neck of the housing body of the purifier. The neck 36 includes a slot generally designated 48 to be described. A pair of spaced-apart parallel, electrically-conductive magnets 50 of the same plurality are provided on the neck 36 that are cooperative to provide a magnetic field that points along the longitudinal axis of the housing body 32.

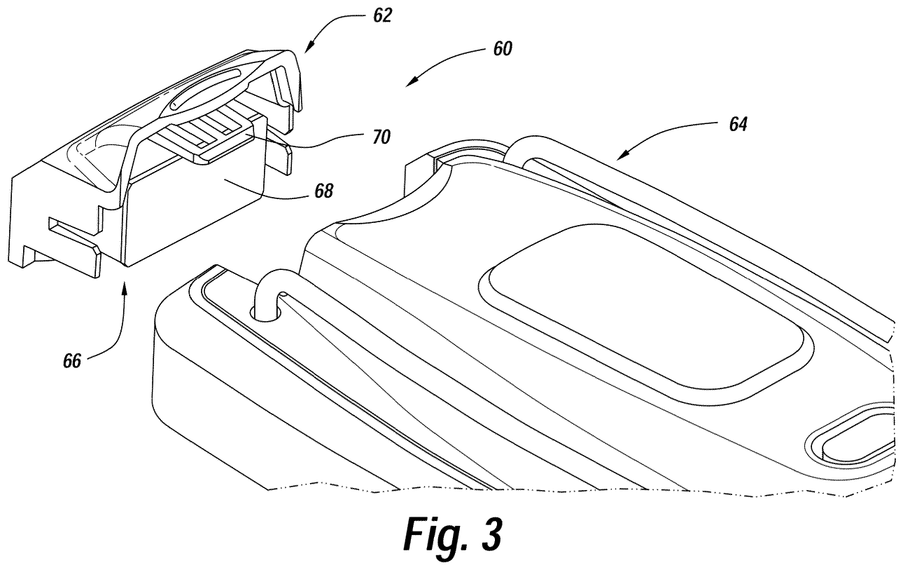

Referring now to FIG. 3, generally designated at 60 is a partial exploded pictorial view showing the emitter head generally designated 62 detached from the housing body generally designated 64 and the inside surface generally designated 66 of the emitter head 62 in its detached condition of the portable rechargeable personal ionic air purifier of present invention. An electrically-conductive plate 68 that extends transversely of the longitudinal axis is mounted to the inside surface of the ion emitter head 62 and is electrically connected to the ion emitter, not shown. The electrically-conductive plate 68 is adapted to contact the electrically-conductive magnets of the pair of magnets 50 (FIG. 2) when the emitter head 62 is seated on the neck 36 (FIG. 2) of the housing body 64. A longitudinally-extending cantilevered arm 70 is provided on the emitter head 62 that cooperates with the slot 48 of the housing body 32 (FIG. 2) to releasably mechanically secure the emitter head 62 and housing body 64 against unintentional dislodgment during use, storage or transport.

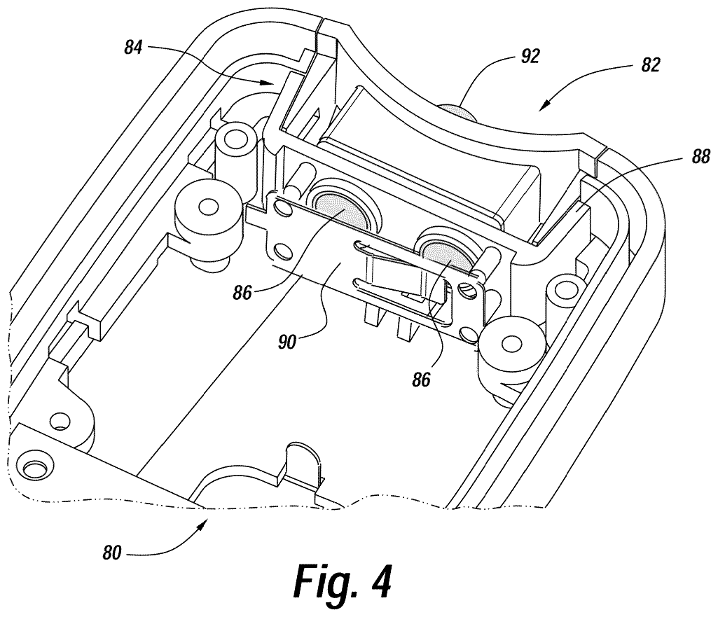

Referring now to FIG. 4, generally designated at 80 is a partial broken away pictorial view showing the emitter head generally designated 82 mounted to the neck generally designated 84 of the housing body generally designated 86 of the portable rechargeable personal ionic air purifier of present invention. A U-shaped carrier 88 is mounted at the neck 84 of the housing body 86 that defines a well adapted to receive the emitter head 82 therewithin. The magnets 86 of the pair of parallel magnets are mounted in apertures provided therefor in the U-shaped carrier 88. A transversely-extending metal contact plate 90 having a spring-arm is mounted to the U-shaped carrier 88 such that the contact plate 88 is resiliently pressed into contact against the confronting surfaces of the electrically-conductive magnets 86. The transversely-extending metal contact 90 is electrically connected to the signal at ionization potential, not shown. As will readily be appreciated, in this manner, current is passed between the transversely-extending conductors 90, 92 via the electrically-conductive magnets 86 sandwiched therebetween, and from thence to the ion emitter 92, by action of electrically-conductive magnetic catch and release.

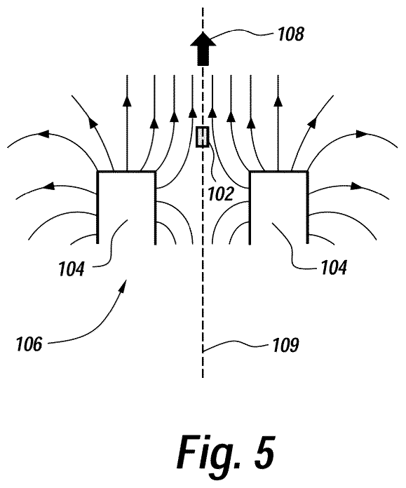

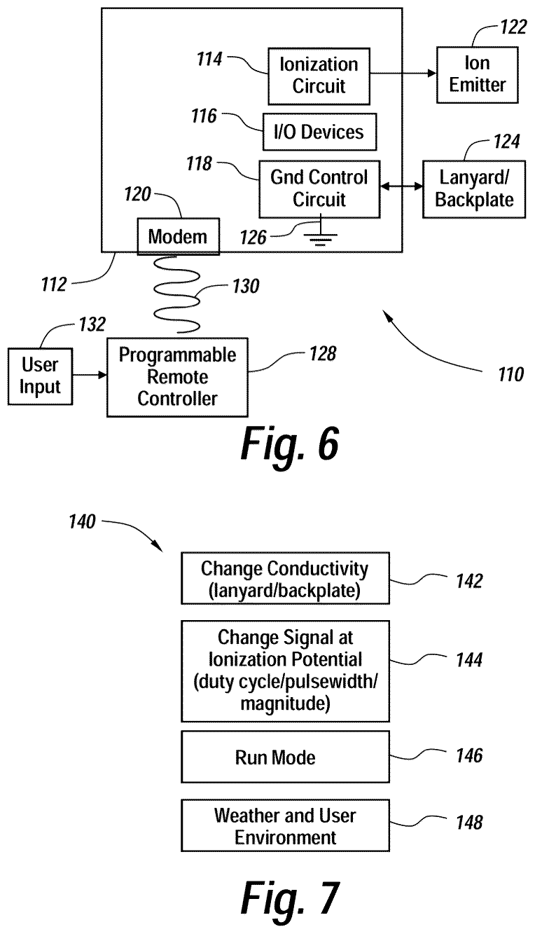

Referring now to FIG. 5, generally designated at 100 is a pictorial diagram that schematically illustrates the synergy provided between the ion emitter 102 of the ion emitter head, not shown, and the pair of parallel magnets 104 at the neck of the housing body, not shown, of the portable rechargeable personal ionic air purifier in accord with the present invention. The parallel magnets 104 provide field lines generally designated 106. As illustrated by vector 108, the field provided between the parallel magnets 104 is directed along the longitudinal axis schematically illustrated by dashed line 109 towards and subtends the longitudinally-extending ion emitter 102. The longitudinally-extending ion emitter is believed to synergistically cooperate with the magnetic field that points along the longitudinal axis provided between the pair of spaced apart parallel magnets to augment ion flow in the breathable air space. Referring now to FIG. 6, generally designated at 110 is a schematic block diagram of the electrical circuitry of one presently preferred remotely-controlled embodiment of the portable rechargeable personal ionic air purifier in accord with the present invention. An electronics module schematically illustrated by box 112 is mounted in the housing body, not shown, and includes a controller and program and data memory, each not shown, well known to those of skill in the art; and an ionization circuit 114, I/O devices 116, such as the on/off LED switch and indicator described above, ground current control circuit 118 and modem 120, all operatively connected to the programmed controller, not shown.

The ionization circuit 114 provides a signal at ionization potential to the ion emitter 122 operatively connected thereto. Preferably, the ionization circuit 114 is the ionization circuit of U.S. Pat. No. 9,737,895. As described above, and as known from U.S. Pat. No. 9,737,895, the ionization circuit 114 is pulse train circuitry controllable in duty cycle, frequency, and among others magnitude that converts battery power to ionization potential to controllably increase and/or decrease the ions generated.

The ground current control circuit 118 controls the current that flows between the lanyard or backplate 124 and floating ground 126. As described above, and as known from U.S. Pat. No. 9,737,895, connecting or disconnecting the lanyard/backplate from ground provides comparatively-larger and comparatively-smaller ground currents and thereby corresponding levels of ion generation in the breathable air space between these extremes. The ground current control circuit 118 preferably includes a multi-level resistance network operatively connected between the ground terminal and the output signal at ionization potential, preferably a three (3) step resistance network, that provides an impedance value and corresponding ground current level defined between the extremes of the comparatively-large and comparatively-small ground current flows provided by the aforesaid U.S. Pat. No. 9,737,895. The resistance network may include more than one (1) level between the outer extremes of comparatively-high and comparatively-low ground current levels and preferably is implemented by a switchable resistor ladder network, although other means, such as a continuously-variable resistor or potentiometer, could be employed without departing from the inventive concepts.

A programmable remote controller 128 is connected to the modem 120 so as to provide a communication interface therebetween such as a blue tooth communication interface schematically illustrated by wavy line 130. The programmable remote controller 128, that is remote from the controller of the module 112 of the purifier, includes a GUI (graphical user interface) and is used as a remote to control the controller of the electronics module 114 in accord with user input mode and control parameter selection as schematically illustrated by box 132. Any device with a controller, GUI and communication interface can provide remote control; preferably, the programmable remote controller 128 is an application adapted for use on an Android smart phone, iPhone, PC, tablet or other web enabled devices, although a stand-alone remote control device could be employed.

Referring now to FIG. 7, generally designated at 140 is a state diagram of the controller of the remotely-controlled embodiment of the portable rechargeable personal ionic air purifier in accord with the present invention.

In charge conductivity (lanyard/backplate) state schematically illustrated by box 142, the controller of the electronics module is operative in response to remote user input control to selectively change the impedance and therewith the current flow through the lanyard/backplate to provide multi-level ion cloud density in accord with selected ground current flows between comparatively-low, comparatively-high and at least one (1) ground current level therebetween. The GUI of the programmable remote controller 128 (FIG. 6) displays fields, not shown, to allow the user to select the desired level of ground current flow.

The change signal at ionization potential state is schematically illustrated by box 144. The controller of the electronics module is operative in response to remote user input control to selectively change the duty cycle, pulse width, and/or magnitude of the signal at ionization potential to controllably increase or decrease ions in the breathable air space. The GUI of the programmable remote controller 128 (FIG. 6) displays fields, not shown, to allow the user to select the desired level of ion flow in the breathable air space.

In run mode state schematically illustrated by box 146, the programmed controller cooperates with the controller of the electronics module to determine and display on its GUI selected device parameters such as battery life, battery health, when and where to buy accessories, usage information, such as hours of use, etc., whether lanyard conductivity is on/off and/or at what intermediate level, what the status of the signal at ionization potential currently is, user manuals, and among others access to product notifications. The GUI of the programmable remote controller 128 (FIG. 6) displays fields, not shown, to allow the user to select and display the information desired.

In weather and user environment state schematically illustrated by box 148, the programmed controller cooperates with the controller of the electronics module to determine and display on its GUI selected environmental parameters such as the forecast pollution level, allergens etc. in order to allow the user to make appropriate adjustments of operating parameters. The pollution level or other status and location of other users in the environment may also be determined and displayed. The GUI of the programmable remote controller 128 displays fields, not shown, to allow the user to determine and display the desired information and to adjust operation parameters based on the information displayed.

Many modifications of the present invention will become apparent to those of skill in the art having benefitted by the instant disclosure without departing from the inventive concepts.

What is claimed is:

1. A portable personal ionic air purifier energizing a personal breathable air space with ions and cleaning particulate pollutants therefrom, comprising:
a housing body having a longitudinal axis, opposing top and bottom ends in spaced-apart relation along said longitudinal axis, a neck at the top end of the housing body and an ionization circuit mounted in the housing body providing a signal at ionization potential; and
an ion emitter head having opposing outer and inside surfaces and an ion emitter longitudinally-extending from off said outer surface thereof mounted for slidable motion defined along said longitudinal axis to said neck of said housing body such that said emitter head is releasably secured mechanically to said neck against unintentionally caused dislodgment while allowing ease of interchange and electrical connection between said ion emitter and said signal at ionization potential by action of electrically-conductive magnetic catch and release.

2. The portable personal ionic air purifier energizing a personal breathable air space with ions and cleaning particulate pollutants therefrom of claim 1, wherein said ion emitter head includes a first electrically-conductive plate that extends transversely of the longitudinal axis mounted to the inside surface of the ion emitter head that is electrically connected to said ion emitter thereof; a pair of spaced-apart and electrically-conductive parallel magnets of the same polarity mounted to the neck of the housing body such that the magnets provide a magnetic field having a direction that points along the longitudinal axis; and a second electrically-conductive plate that extends transversely of the longitudinal axis that is mounted to said neck and that is electrically connected to said signal at ionization potential.

3. The portable personal ionic air purifier energizing a personal breathable air space with ions and cleaning particulate pollutants therefrom of claim 2, wherein the first electrically-conductive plate of the emitter head is releasably attached to the pair of parallel magnets of the neck of the housing body by action of magnetic catch and release and the signal at ionization potential is electrically connected to said emitter via the first and second transversely-extending conductive plates and said pair of parallel electrically-conductive magnets sandwiched between.

4. The portable personal ionic air purifier energizing a personal breathable air space with ions and cleaning particulate pollutants therefrom of claim 2, wherein the inside surface of the ion emitter head includes a longitudinally-extending cantilever arm and first and second transversely spaced-apart and longitudinally-extending walls defining first and second longitudinally-extending guide slots that respectively cooperate with first and second transversely spaced-apart guide rails provided on the neck of the housing body to releasably mechanically secure the emitter head and housing body against unintended dislodgment.

5. The portable personal ionic air purifier energizing a personal breathable air space with ions and cleaning particulate pollutants therefrom of claim 1, wherein said ionization circuit includes a terminal at ground potential.

6. The portable personal ionic air purifier energizing a personal breathable air space with ions and cleaning particulate pollutants therefrom of claim 5, further including a member for releasably attaching an electrically-conductive lanyard to said terminal at ground potential.

7. The portable personal ionic air purifier energizing a personal breathable air space with ions and cleaning particulate pollutants therefrom of claim 6, further including an electrically-conductive lanyard.

8. The portable personal ionic air purifier energizing a personal breathable air space with ions and cleaning particulate pollutants therefrom of claim 1, wherein a pair of spaced-apart and electrically-conductive parallel magnets of the same polarity are mounted to the neck of the housing body such that the magnets provide a magnetic field having a direction that points along the longitudinal axis towards and subtends the longitudinally-extending ion emitter.

9. A portable personal ionic air purifier energizing a personal breathable air space with ions and cleaning particulate pollutants therefrom, comprising:
a housing;
an ionization circuit having a terminal connected to electrical ground and an output providing a signal at ionization potential;
an ion emitter that emits ions when energized at ionization potential by said signal at ionization potential along a circuit path that includes said ion emitter and said terminal at ground potential; and
a multi-level impedance network connected in said circuit to selectively vary the impedance between one of the extremes of comparatively-high and comparatively-low impedance and at least one (1) impedance value between said extremes.

10. The portable personal ionic air purifier energizing a personal breathable air space with ions and cleaning particulate pollutants therefrom of claim 9, further including a member for releasably attaching an electrically-conductive lanyard to said terminal at ground potential.

11. The portable personal ionic air purifier energizing a personal breathable air space with ions and cleaning particulate pollutants therefrom of claim 10, further including an electrically-conductive lanyard.

12. A portable personal ionic air parameters energizing a personal breathable air space with ions and cleaning particulate pollutants therefrom of the present invention, comprising:
a housing adapted to be transportable and personally worn;
an ion emitter outwardly extending from said housing;
an electronics module in the housing including a controller and an ionization circuit having a terminal connected to electrical ground and an output that provides a signal at ionization potential;
said ion emitter, that emits ions when energized by said signal at ionization potential, is connected along a circuit that includes said ion emitter and said terminal at ground potential causing thereby ground current to flow along said circuit path; and
a remote control device having a controller and GUI that cooperates with said controller of said electronics module to controllably provide intuitive and informative operational modes in different selectable operable states.

13. The portable personal ionic air purifier energizing a personal breathable air space with ions and cleaning particulate pollutants therefrom of claim 12, wherein, in a change signal at ionization potential state, said signal at ionization potential is controllably varied to change ion flow in the breathable air space.

14. The portable personal ionic air purifier energizing a personal breathable air space with ions and cleaning particulate pollutants therefrom of claim 13, wherein said signal at ionization potential is a pulse train signal that has a pulse width, duty cycle and pulse magnitude, and wherein said signal at ionization potential is controllably varied in one of said pulse width, duty cycle and pulse magnitude to selectably change ion flow in the breathable air space

15. The portable personal ionic air purifier energizing a personal breathable air space with ions and cleaning particulate pollutants therefrom of claim 12, wherein, in a change ground conductivity state, the impedance of said circuit path is controllably selected to change the ion flow in the breathable air space between comparatively-high and comparatively-low extremes of ion flow and at least one (1) level of ion flow therebetween.

16. The portable personal ionic air purifier energizing a personal breathable air space with ions and cleaning particulate pollutants therefrom of claim 12, wherein, in a run state, selectable air purifier parameters such as battery life, health and hours of operation are determined and displayed.

17. The portable personal ionic air purifier energizing a personal breathable air space with ions and cleaning particulate pollutants therefrom of claim 12, wherein, in a weather and user environment state, selectable environmental parameters such as forecast pollution levels, allergens, etc are determined and displayed.

18. The portable personal ionic air purifier energizing a personal breathable air space with ions and cleaning particulate pollutants therefrom of claim 12, wherein said remote control device is a smart phone application.

19. The portable personal ionic air purifier energizing a personal breathable air space with ions and cleaning particulate pollutants therefrom of claim 12, wherein said controller of said remote control device cooperates with said controller of said electronics module via a communications interface.

20. The portable personal ionic air purifier energizing a personal breathable air space with ions and cleaning particulate pollutants therefrom of claim 19, wherein said interface is a Bluetooth protocol communication interface.
